(19) United States
(12) Patent Application Publication
(10) Pub. No.: US 2016/0341636 A1
(43) Pub. Date: Nov. 24, 2016

(54) SYSTEM AND METHOD FOR IMPROVED PRODUCTION SURVEILLANCE USING VISUAL PATTERN RECOGNITION IN OIL AND GAS UPSTREAM

(71) Applicant: Wipro Limited, Bangalore (IN)

(72) Inventors: Venkatakrishnan Rajaram, Bengaluru (IN); Hemant Kumar, Bangalore (IN)

(21) Appl. No.: 14/794,424

(22) Filed: Jul. 8, 2015

(30) Foreign Application Priority Data
May 20, 2015 (IN) 2536/CHE/2015

(51) Int. Cl. G01M 99/00; E21B 47/00

(52) U.S. Cl. CPC G01M 99/008; E21B 47/00

(57) ABSTRACT

A method and production surveillance device to perform oil and/or gas upstream surveillance that generates one or more real-time patterns from sensor data received from one or more sensors. The one or more real-time patterns are compared with one or more pre-defined patterns. A confidence prediction score is determined based on the comparison of the one or more real-time patterns with the one or more pre-defined patterns. One or more alerts are generated based on the confidence prediction score to perform oil and/or gas upstream surveillance.

This application claims the benefit of Indian Application Serial No. 2536/CHE/2015 filed May 20, 2015, which is hereby incorporated by reference in its entirety.

### TECHNICAL FIELD

This disclosure relates generally to monitoring mechanical equipment in oil and/or gas production, and more particularly to a system and method for improved production surveillance using visual pattern recognition in oil and/or gas upstream.

### BACKGROUND

Oil and/or gas industry value chain may include various high level business processes. The business processes may be upstream which may include exploration of oil and gas in earth's crust and production which may involve extraction of oil and/or gas from the reservoirs underground, midstream which may include extensive pipelines and ships that carry the oil and/or gas extracted to refineries and downstream which may involve storage (crude as well as refined produce), refining, shipping and transportation of refined product to terminals/gas stations for further sale to end customers.

The upstream production area of business process value chain, may involve optimizing production (extraction of crude) from identified reservoirs beneath the earth through effective intervention to identify underperforming equipment used in the extraction process. Traditionally, extraction of oil and/or gas through various assets (reservoirs, wells, facilities) may involve deployment of extensive mechanical equipment like electronic submersible pumps, chokes, motors etc. over extended periods of time (lasting for many years).

Typically, the extensive mechanical equipment may be prone to performance degradation over a period of time. Timely intervention to understand if extensive mechanical equipment is performing at optimum levels or if extensive mechanical equipment requires replacement may be very critical to ensure maximum oil and/or gas extraction. Delayed discovery of under performing assets may result in heavy losses in production.

### SUMMARY

In one embodiment, a production surveillance device is disclosed. The production surveillance device may comprise a memory; a processor coupled to the memory storing processor executable instructions which when executed by the processor causes the processor to perform operations comprising: generating one or more real-time patterns from sensor data received from one or more sensors; comparing the one or more real-time patterns with one or more pre-defined patterns; determining a confidence prediction score based on the comparison of the one or more real-time patterns with the one or more pre-defined patterns; and generating one or more alerts based on the confidence prediction score to perform oil and/or gas upstream surveillance

In another embodiment, a method to perform oil and/or gas upstream surveillance is disclosed. The method comprises: generating, by a production surveillance device, one or more real-time patterns from sensor data received from one or more sensors; comparing, by the production surveillance device, the one or more real-time patterns with one or more pre-defined patterns; determining, by the production surveillance device, a confidence prediction score based on the comparison of the one or more real-time patterns with the one or more pre-defined patterns; and generating, by the production surveillance device, one or more alerts based on the confidence prediction score to perform oil and/or gas upstream surveillance.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary diagram for an environment with a production surveillance device.

FIG. 2 is a functional block diagram of a memory storing modules to perform oil and/or gas upstream surveillance according to some embodiments of the present disclosure.

FIG. 3 illustrates an exemplary flow diagram of a method to perform oil and/or gas upstream surveillance.

FIG. 4 illustrates comparison of the real time patterns and pre-defined patterns of Flowing Bottom Hole Pressure (FBHP).

FIG. 5 illustrates comparison of the real time patterns and pre-defined patterns of Flowing Tubing Head Pressure (FTHP).

FIG. 6 illustrates comparison of the real time patterns and pre-defined patterns of Flowing Tubing Head Temperature (FTHT).

FIG. 7 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

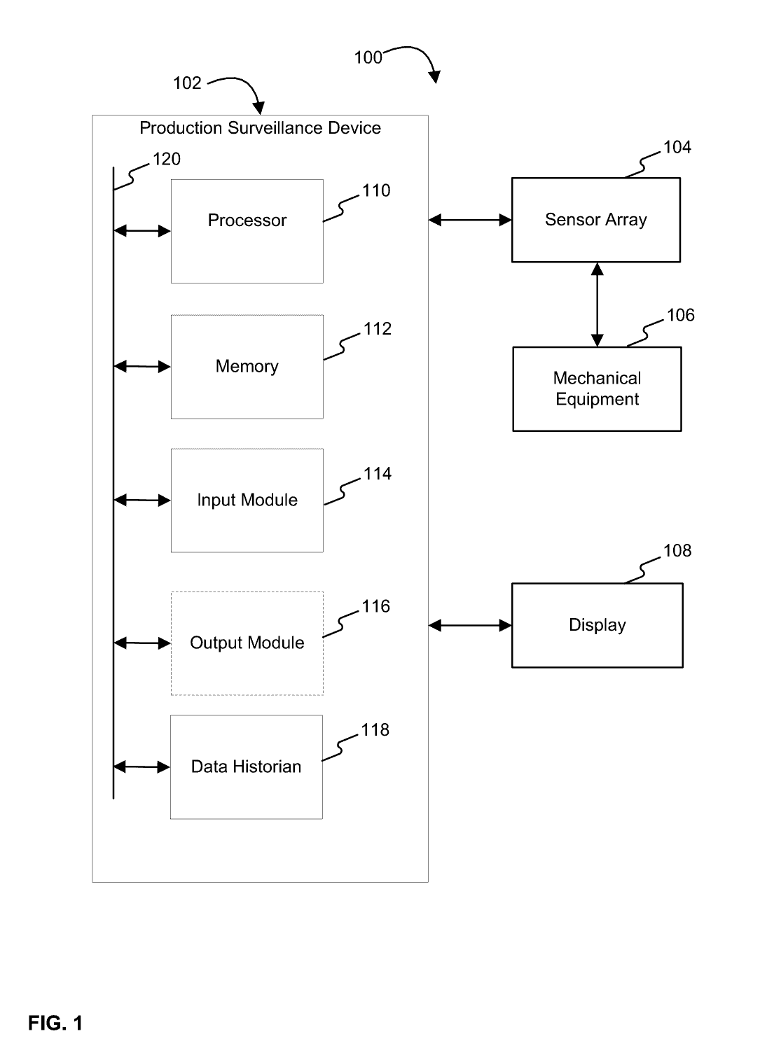

FIG. 1 illustrates an exemplary diagram for an environment 100 for a production surveillance device 102 to perform production surveillance in oil and/or gas upstream. The exemplary environment may include a production surveillance device 102, a sensor array 104, one or more mechanical equipment such as mechanical equipment 106 and a display 108. The production surveillance device 102 may further include a processor 110, a memory 112, an input module 114, an output module 116, a data historian module 118. While not shown, the exemplary environment 100 may include additional components, such as database etc which are well known to those of ordinary skill in the art and thus will not be described here. The sensor array 104 may include one or more sensors connected to mechanical equipment 106 to capture one or more transactional parameters associated with the mechanical equipment 106. The one or more transactional parameters may be temperature, pressure and/or flow by way of example only. The one or more transactional parameters may also be Flowing Bottom Hole Pressure (FBHP), Flowing Tubing Head Pressure (FTHP) and/or Flowing Tubing Head Temperature (FTHT) by way of example only. The one or more transactional parameters may need to be tracked to control the running of oil and/or gas production upstream as well as for post-facto analysis. The mechanical equipment 106 may be electronic submersible pumps, chokes, motors, etc. The display 108 may be used to provide visual alerts in different visual formats (web-based or geographic information system GIS) or as mobile apps.

The production surveillance device 102 may perform oil and/or gas upstream surveillance and is described with examples herein, although the production surveillance device 102 may perform other types and/or functions. The production surveillance device 102 may include a processor 110, a memory 112, an input module 114, an output module 116, and a data historian module 118 which may be coupled together by bus 120, although the production surveillance device 102 may comprise other types and numbers of element in other configurations.

Processor 110 may execute one or more computer-executable instructions stored in the memory 112 for the methods illustrated and described with reference to the examples herein, although the processor(s) can execute other types and numbers of instructions and perform other types and numbers of operations. The processor(s) 110 may comprise one or more central processing units (“CPUs”) or general purpose processors with one or more processing cores, such as AMD® processor(s), although other types of processor(s) could be used (e.g., Intel®).

The memory 112 may comprise one or more tangible storage media, such as RAM, ROM, flash memory, CD-ROM, floppy disk, hard disk drive(s), solid state memory, DVD, or other memory storage types or devices, including combinations thereof, which are known to those of ordinary skill in the art. The memory 112 may store one or more non-transitory computer-readable instructions of this technology as illustrated and described with reference to the examples herein that may be executed by the one or more processor(s) 110.

The input module 114 may receive sensor data from the sensor array 104.

The output module 116 may link the production surveillance device 102 with peripheral devices such as the display 108.

The data historian module 118 may be a real-time data-delivery mechanism, performing mathematical operations that aggregate and transform acquired data. The data historian module 118 may be used to record trends and historical information about industrial processes for future reference. The data historian module 118 may capture plant management information about production status, performance monitoring, quality assurance, tracking and genealogy, and product delivery with enhanced data capture, data compression, and data presentation capabilities. The sensor data captured may be relayed into the data historian where the sensor data can be stored.

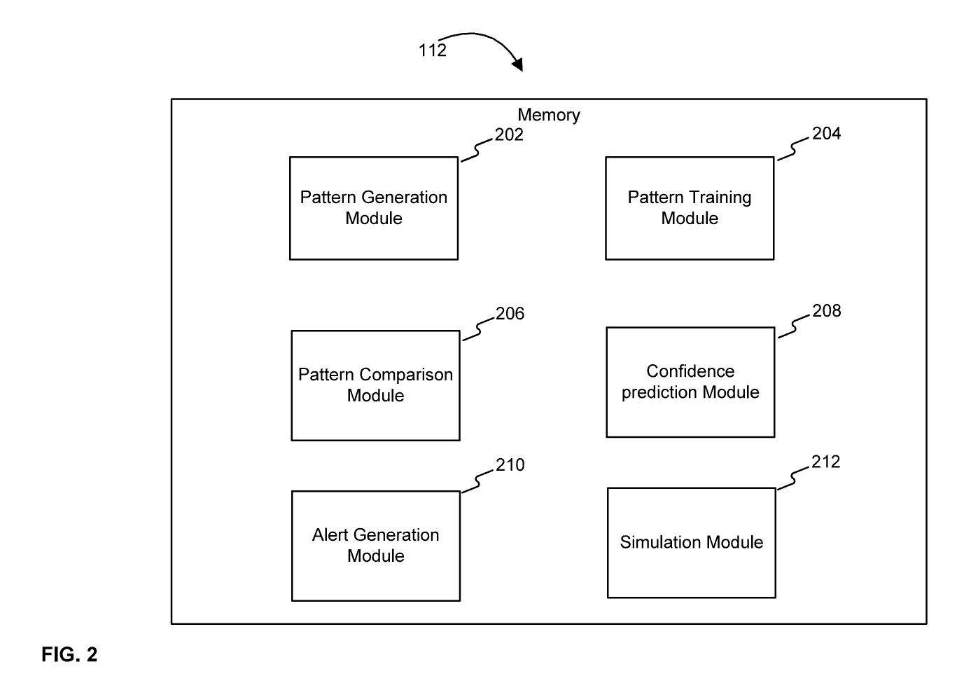

FIG. 2 illustrates the memory 112 which may include a pattern generation module 202, pattern training module 204, pattern comparison module 206, confidence prediction module 208, alert generation module 210, and/or simulation module 212 by way of example only, although other types, numbers and/or combinations of modules and/or other programmed instructions for this technology may be used.

The pattern generation module 202 may generate one or more real-time patterns from sensor data received from one or more sensors. The pattern generation module 202 may receive the sensor data received from a data historian module 118. The data historian module 118 may receive the sensor data from the one or more sensors (sensor array 104). The sensor data may be aggregated over a primary time interval for one or more transactional parameters associated with mechanical equipment 106 by the data historian module 118. The sensor data may also be normalized over the primary time interval by the data historian module 118.

The pattern comparison module 206 may compare the one or more real time patterns with one or more predefined patterns. The one or more pre-defined patterns may be one or more pre-recorded patterns associated with one or more equipment failure events. The one or more equipment failure events may be a gas oil ratio event or a water-cut ratio event by way of example only. A gas oil ratio may the ratio of volumetric flow of produced gas to the volumetric flow of crude oil for crude oil and/or gas mixture sample. For hydrocarbon mixture produced from an oil production well, the proportion of liquid and vapor phases in the hydrocarbon mixture may change with changing temperature and pressure conditions. The gas oil ratio event may occur when the gas oil ratio may exceed a threshold value. A water cut ratio may be ratio of water produced compared to volume of total liquids produced from the oil production well. Similarly, the water cut ratio event may occur when the water cut ratio may exceed a threshold value. The one or more pre-recorded patterns may be generated by pattern training module 204 from the sensor data received from the one or more sensors in the past stored in the data historian module 118. The sensor data may be extrapolated for the one or more equipment failure events for a secondary time interval. The secondary time interval may be multiple time intervals such as 1 hour, 4, hours, 6 hours, 24 hours, 72 hours, 1 week, 1 month, etc. The extrapolated sensor data may be simulated to generate the one or more pre-recorded patterns associated with the one or more equipment failure events by simulation module 212. The one or more pre-recorded patterns associated with the one or more equipment failure events may also be normalized by simulation module 212. After normalization, the one or more pre-recorded patterns associated with the one or more equipment failures event may be stored in a database.

The confidence prediction module 208 may determine a confidence prediction score based on the comparison of the one or more real-time patterns with the one or more pre-defined patterns. The confidence prediction score may represent likelihood occurrence of the one or more equipment failure events based on the comparison of the one or more real-time patterns with the one or more pre-defined patterns. The confidence prediction score may be determined as modulus of percentile (PR) value of the one or more real-time patterns and mean percentile (MP) value of the one or more pre-defined patterns subtracted from 100.

Confidence Prediction=100−(|MP−(PR)|*100/mean range)

For example, if the percentile value (PR) for real-time pattern of Flowing Bottom Hole Pressure (FBHP) is 234, the mean percentile (MP) for pre-defined pattern of Flowing Bottom Hole Pressure (FBHP) is 250 and mean range of Flowing Bottom Hole Pressure (FBHP) is 50 (between 200-300), then the confidence prediction score for FBHP pattern comparison is calculated as:

Confidence Prediction=100−(|250−234|*100/50)

The alert generation module 210 may generate one or more alerts based on the confidence prediction score to perform oil and/or gas upstream surveillance. Based on the confidence prediction score, for each of the one or more real-time pattern of each of the one or more transactional parameters, a pattern match score may be determined. A pattern match score may be average of the one or more confidence prediction scores for the one or more real-time patterns of the one or more transactional parameters. If the pattern match score is above or below a pre-determined threshold level, then the one or more alerts may be generated. The one or more alerts may be in one or more visual or audio forms (web-based or geographic information system GIS) or as mobile apps to the user.

The pattern training module 204 may be updated with the one or more real time patterns for improving predictive analysis. The one or more real time patterns may be updated into pattern training module 204. The one or more real time patterns may now be treated as one or more pre-defined patterns for subsequent iterations. Updating the one or more real time patterns to pattern training module 204 may ensure a continuous learning model in place to minimize false alarms.

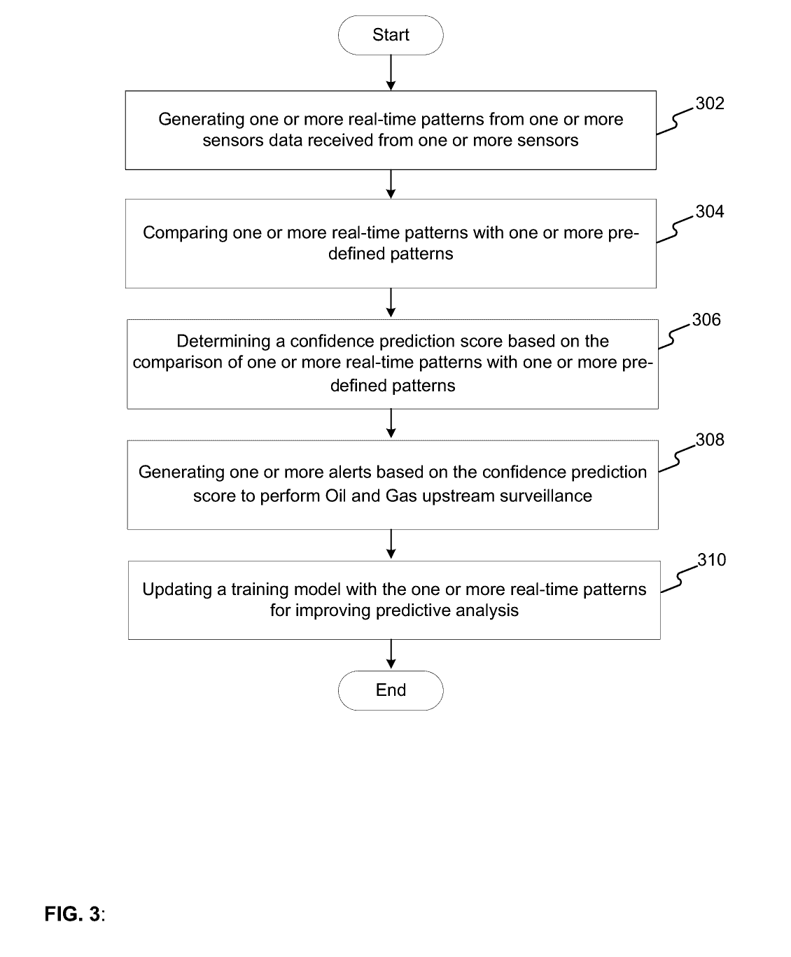

FIG. 3 illustrates an example of a flow diagram of a method for performing oil and/or gas upstream surveillance. This example of the method may involve generating, by a production surveillance device 102, one or more real-time patterns from sensor data received from one or more sensors at step 302. The one or more real-time patterns may be generated by pattern generation module 202 from the sensor data received from a data historian module 118. The data historian module 118 may receive the sensor data from the one or more sensors (sensor Array 104). The sensor data may be aggregated over a primary time interval for one or more transactional parameters associated with mechanical equipment 106 by the data historian module 118. The sensor data also may be normalized over the primary time interval by the data historian module 118.

The one or more real time patterns may be compared with one or more predefined patterns by the pattern comparison module 206 at step 304. The one or more pre-defined patterns may be one or more pre-recorded patterns associated with one or more equipment failure events. The one or more equipment failure events may be a high gas oil ratio or a high water-cut ratio by way of example only. A gas oil ratio may the ratio of volumetric flow of produced gas to the volumetric flow of crude oil for crude oil and/or gas mixture sample. For any hydrocarbon mixture produced from an oil production well, the proportion of liquid and vapor phases in the mixture may change with changing temperature and/or pressure conditions by way of example. The gas oil ratio event may occur when the gas oil ratio may exceed a threshold value by way of example. A water cut ratio may be ratio of water produced compared to volume of total liquids produced from the oil production well. Similarly, the water cut ratio event may occur when the water cut ratio may exceed a threshold value. The one or more pre-recorded patterns may be generated by pattern training module 204 from the sensor data received from the one or more sensors in the past stored in the data historian module 118. The sensor data may be extrapolated for the one or more equipment failure events for a secondary time interval. The secondary time interval may be multiple time intervals such as 1 hour, 4, hours, 6 hours, 24 hours, 72 hours, 1 week, 1 month, etc. The extrapolated sensor data may be simulated to generate the one or more pre-recorded patterns associated with one or more equipment failure events by simulation module 212. The one or more patterns associated with the one or more equipment failure events may also be normalized by simulation module 212. After normalization, the one or more patterns associated with the one or more equipment failures event may be stored in a database.

Based on the comparison of one or more real-time patterns with one or more pre-defined patterns, a confidence prediction score may be determined by confidence prediction module 208 at step 306. The confidence prediction score may represent likelihood occurrence of the one or more equipment failure events based on the comparison of the one or more real-time patterns with the one or more pre-defined patterns. The confidence prediction score may be determined as modulus of percentile value (PR) of the one or more real-time patterns and mean percentile (MP) value of the one or more pre-defined patterns subtracted from 100.

Confidence Prediction=100−(|MP−(PR)|*100/mean range)

One or more alerts based on the confidence prediction score to perform oil and/or gas upstream surveillance by alert generation module 210 at step 308. Based on the confidence prediction score, for each of the one or more real-time pattern of each of the one or more transactional parameters, a pattern match score may be determined. A pattern match score may be average of the one or more confidence prediction scores for the one or more real-time pattern of the one or more transactional parameters. If the pattern match score is above or below a pre-determined threshold level, then the one or more alerts may be generated. The one or more alerts may be in one or more visual or audio forms (web-based or geographic information system GIS) or as mobile apps to the user.

At step 310, the one or more real time pattern may be updated to pattern training module 204 for improving predictive analysis. The one or more real time pattern may be updated into pattern training module 204. The one or more real time patterns may then be treated as the one or more pre-defined patterns. Updating the one or more real time patterns to pattern training module 204 may ensure a continuous learning model in place to minimize false alarms.

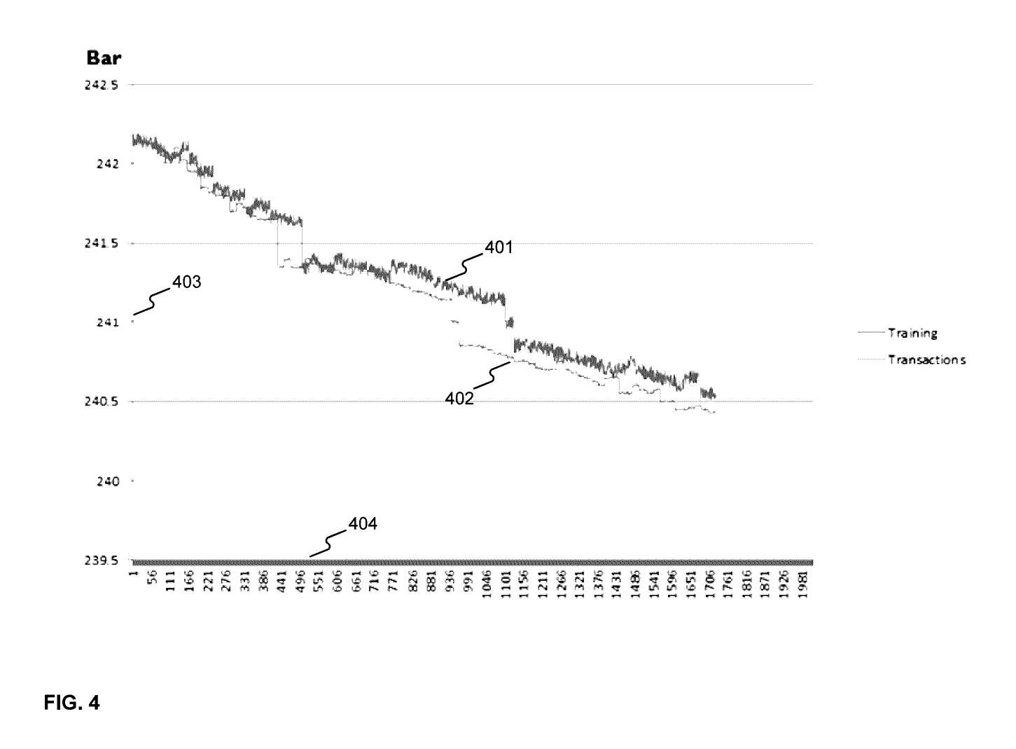

FIG. 4-6 illustrates examples of oil and/or gas upstream surveillance graphical plot real time patterns and pre-defined patterns for equipment failure event; high gas oil ratio. The one or more transactional parameters may be Flowing Bottom Hole Pressure (FBHP), Flowing Tubing Head Pressure (FTHP) and Flowing Tubing Head Temperature (FTHT).

FIG. 4 illustrates a comparison of the real time patterns 401 and pre-defined patterns 402 of Flowing Bottom Hole Pressure (FBHP). The y axis 403 may relate to FBHP. The x axis 404 may be related to time in seconds. The sensor data of Flowing Bottom Hole Pressure (FBHP) may be aggregated over a primary time interval (55 seconds) associated with mechanical equipment 106 by the data historian module 118. The sensor data of Flowing Bottom Hole Pressure (FBHP) may be normalized over the primary time interval by the data historian module 118. A confidence prediction score based on the comparison of the real time patterns 401 and pre-defined patterns 402 of Flowing Bottom Hole Pressure (FBHP) may be determined by confidence prediction module 208.

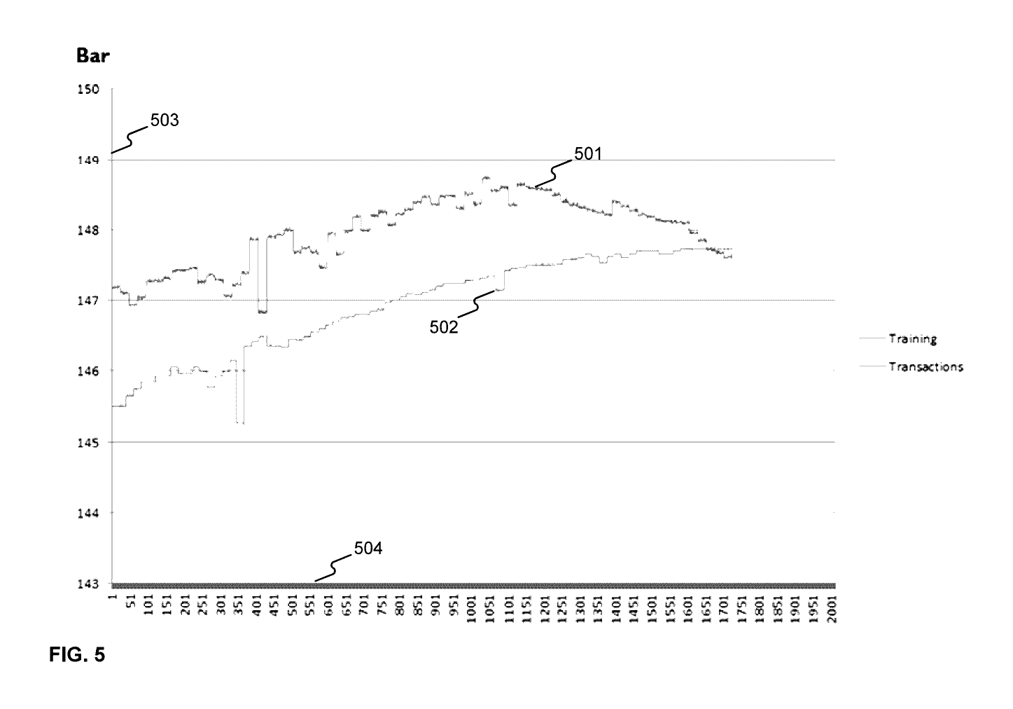

FIG. 5 illustrates comparison of the real time patterns 501 and pre-defined patterns 502 of Flowing Tubing Head Pressure (FTHP). The y axis 503 may relate to FBHP. The x axis 504 may be related to time in seconds. The sensor data of Flowing Tubing Head Pressure (FTHP) may be aggregated over a primary time interval (55 seconds) associated with mechanical equipment 106 by the data historian module 118. The sensor data of Flowing Tubing Head Pressure (FTHP) may be normalized over the primary time interval by the data historian module 118. A confidence prediction score based on the comparison of the real time patterns 501 and pre-defined patterns 502 of Flowing Bottom Hole Pressure (FBHP) may be determined by confidence prediction module 208.

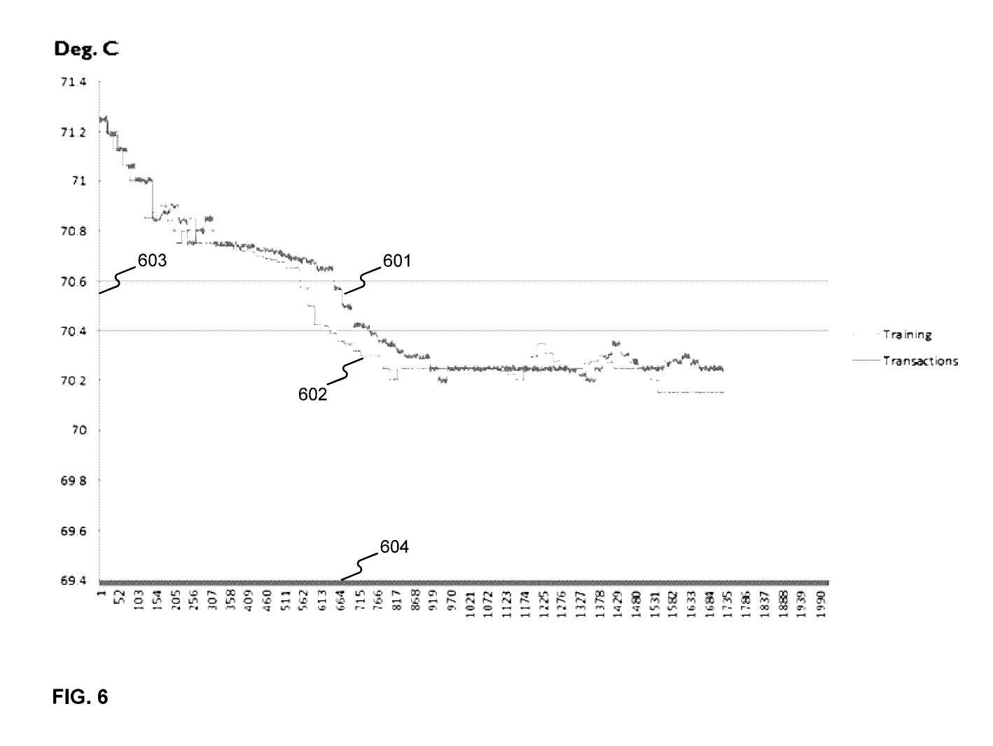

FIG. 6 illustrates comparison of the real time patterns 601 and pre-defined patterns 602 of Flowing Tubing Head Temperature (FTHT). The y axis 603 may relate to FTHT. The x axis 604 may be related to time in seconds. The sensor data of Flowing Tubing Head Temperature (FTHT) may be aggregated over a primary time interval (55 seconds) associated with mechanical equipment 106 by the data historian module 118. The sensor data of Flowing Tubing Head Temperature (FTHT) may be normalized over the primary time interval by the data historian module 118. A confidence prediction score based on the comparison of the real time patterns 601 and pre-defined patterns 602 of Flowing Tubing Head Temperature (FTHT) may be determined by confidence prediction module 208.

The confidence prediction score for FBHP, FTHP and FTHT may be averaged to determine a pattern match score. For example, if the confidence prediction score for FBHP is 92.42, FTHP 61.55 and FTHT 94.28, the pattern match score may be 82.75.

### Computer System or Device

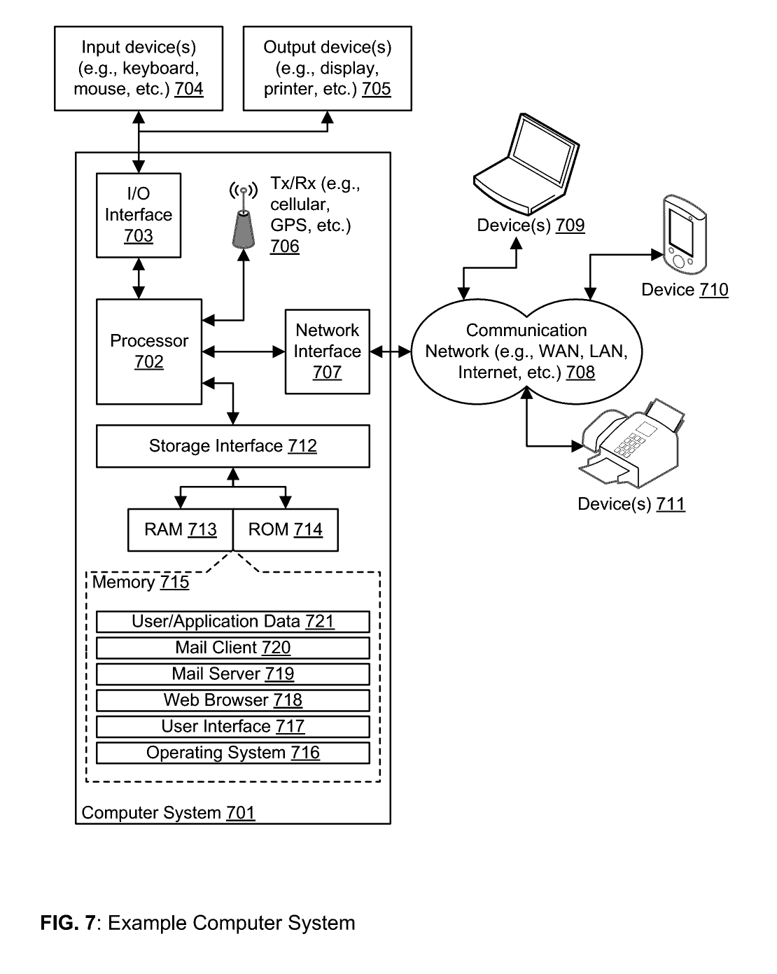

FIG. 7 is a block diagram of an exemplary computer system or device 701 for implementing embodiments consistent with the present disclosure. Variations of computer system or device 701 may be used for implementing a production surveillance device. In this example, the computer system 701 may comprise a central processing unit (“CPU” or “processor”) 702. Processor 702 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 702 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPgas), etc.

Processor 702 may be disposed in communication with one or more input/output (I/O) devices via I/O interface 703. The I/O interface 703 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 703, the computer system 701 may communicate with one or more I/O devices. For example, the input device 704 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 705 may be a printer, fax machine, video display (e.g., cathode ray tube (CRT), liquid crystal display (LCD), light-emitting diode (LED), plasma, or the like), audio speaker, etc. In some embodiments, a transceiver 706 may be disposed in connection with the processor 702. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 702 may be disposed in communication with a communication network 708 via a network interface 707. The network interface 707 may communicate with the communication network 708. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 708 may include, without limitation, a direct interconnection, local area network (LAN), wide area network (WAN), wireless network (e.g., using Wireless Application Protocol), the Internet, etc. Using the network interface 707 and the communication network 708, the computer system 701 may communicate with devices 710, 711, and 712. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 701 may itself embody one or more of these devices.

In some embodiments, the processor 702 may be disposed in communication with one or more memory devices (e.g., RAM 713, ROM 714, etc.) via a storage interface 712. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 716, user interface application 717, web browser 718, mail server 719, mail client 720, user/application data 721 (e.g., any data variables or data records discussed in this disclosure), etc. The operating system 716 may facilitate resource management and operation of the computer system 701. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 717 may facilitate display, execution, interaction, manipulation, or operation of program components through textual or graphical facilities. For example, user interfaces may provide computer interaction interface elements on a display system operatively connected to the computer system 701, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 701 may implement a web browser 718 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 701 may implement a mail server 719 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObj ects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 701 may implement a mail client 720 stored program component. The mail client may be a mail viewing application, such as Apple Mail, Microsoft Entourage, Microsoft Outlook, Mozilla Thunderbird, etc.

In some embodiments, computer system 701 may store user/application data 721, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described a system and method for improved production surveillance using visual pattern recognition in oil and/or gas upstream. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more non-transitory computer-readable storage media may be utilized in implementing embodiments consistent with the present disclosure. A non-transitory computer-readable storage medium refers to any type of physical memory on which information or data readable by a processor may be stored. Thus, a non-transitory computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for performing oil and/or gas upstream surveillance, the method comprising:
generating, by a production surveillance device, one or more real-time patterns from sensor data received from one or more sensors;
comparing, by the production surveillance device, the one or more real-time patterns with one or more pre-defined patterns;
determining, by the production surveillance device, a confidence prediction score based on the comparison of the one or more real-time patterns with the one or more pre-defined patterns; and
generating, by the production surveillance device, one or more alerts based on the confidence prediction score to perform oil and/or gas upstream surveillance.

2. The method of claim 1, further comprising updating, by the production surveillance device, the one or more real-time patterns.

3. The method of claim 1, wherein the one or more pre-defined patterns comprises one or more pre-recorded patterns associated with one or more equipment failure events.

4. The method of claim 3, wherein the one or more equipment failure events comprises a gas-oil-ratio event or a water-cut ratio event.

5. The method of claim 3, further comprising generating, by the production surveillance device, the one or more pre-recorded patterns by extrapolating, simulating and normalizing the sensor data for the one or more equipment failure events.

6. The method of claim 1, further comprising determining, by the production surveillance device, the confidence prediction score as a normalized form of the sensor data expressed in terms of a percentile value and a mean percentile.

7. A production surveillance device comprising:
a processor;
a memory, wherein the memory is coupled to the processor which is configured to be capable of executing programmed instructions, which comprise the programmed instructions stored in the memory to:
generate one or more real-time patterns from sensor data received from one or more sensors.
compare the one or more real-time patterns with one or more pre-defined patterns;
determine a confidence prediction score based on the comparison of the one or more real-time patterns with the one or more pre-defined patterns; and
generate one or more alerts based on the confidence prediction score to perform oil and/or gas upstream surveillance.

8. The production surveillance device of claim 7, wherein the memory coupled to the processor further comprises the programmed instructions stored in the memory to update a training model with the one or more real-time patterns.

9. The production surveillance device of claim 7, wherein the one or more pre-defined patterns comprise one or more pre-recorded patterns associated with one or more equipment failure events.

10. The production surveillance device of claim 9, wherein the one or more equipment failure events comprises a gas-oil-ratio event or a water-cut ratio event.

11. The production surveillance device of claim 9, wherein the memory coupled to the processor further comprises the programmed instructions stored in the memory to generate the one or more pre-recorded patterns by extrapolating, simulating and normalizing the sensor data for the one or more equipment failure events.

12. The production surveillance device of claim 7, wherein the memory coupled to the processor further comprises the programmed instructions stored in the memory to determine the confidence prediction score as a normalized form of the sensor data expressed in terms of a percentile value and a mean percentile.

13. A non-transitory computer readable medium having stored thereon instructions for performing oil and/or gas upstream surveillance comprising machine executable code which when executed by at least one processor, causes the processor to perform steps comprising:
generating one or more real-time patterns from sensor data received from one or more sensors.
comparing the one or more real-time patterns with one or more pre-defined patterns;
determining a confidence prediction score based on the comparison of the one or more real-time patterns with one or more pre-defined patterns; and
generating one or more alerts based on the confidence prediction score to perform oil and/or gas upstream surveillance.

14. The medium of claim 13, further comprising updating a training model with the one or more real-time patterns.

15. The medium of claim 13, wherein the one or more pre-defined patterns comprises one or more pre-recorded patterns associated with one or more equipment failure events.

16. The medium of claim 15, wherein the one or more equipment failure events comprise a gas-oil-ratio event or a water-cut ratio event.

17. The medium of claim 15, further comprising generating the one or more pre-recorded patterns by extrapolating, simulating and normalizing the sensor data for the one or more equipment failure events.

18. The medium of claim 13, further comprising determining the confidence prediction score as a normalized form of the sensor data expressed in terms of a percentile value and a mean percentile.
